(19) United States
(12) Patent Application Publication
(10) Pub. No.: US 2006/0139245 A1
(43) Pub. Date: Jun. 29, 2006

(54) Projection video display apparatus and brightness adjustment method therefor

(76) Inventor: Tooru Sugiyama, Kumagaya-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/316,464

(22) Filed: Dec. 22, 2005

(30) Foreign Application Priority Data
Dec. 27, 2004 (JP) 2004-378183

(51) Int. Cl. G09G 3/28

(52) U.S. Cl. 345/60

(57) ABSTRACT

This invention is applied to a projection video display apparatus which causes a DMA to modulate light from a light source having a plurality of two-dimensionally arrayed LEDs in accordance with a video signal and projects the modulated video light onto a screen via a projection optical lens. The two-dimensionally arrayed LEDs are sequentially turned off from outside to inside when a drive device for ON/OFF-driving the LEDs of the light source is designated to darken the light source. Alternatively, the two-dimensionally arrayed light-emitting elements are sequentially turned on from inside to outside when the drive device is designated to brighten the light source.

### CROSS-REFERENCE TO RELATED APPLICATIONS

This application is based upon and claims the benefit of priority from prior Japanese Patent Application No. 2004-378183, filed Dec. 27, 2004, the entire contents of which are incorporated herein by reference.

### BACKGROUND OF THE INVENTION

1. Field of the Invention

The present invention relates to a projection video display apparatus which uses an optical space modification element such as a digital micromirror device (DMD).

2. Description of the Related Art

As a space modification element, a projection video display apparatus which uses a digital micromirror device (DMD) is available. Conventionally, this type of video display apparatus uses a lamp as a light source. However, recently, the video display apparatus uses two-dimensionally arrayed LEDs (Light-Emitting Diodes) as one light source (e.g., Jpn. Pat. Appln. KOKAI Publication No. 10-269802).

In the two-dimensional LED light source, brightness/darkness is controlled in accordance with the number of ON LEDs. However, when the LEDs are turned off at random in accordance with an increase/decrease in brightness, a light quantity on a projection image becomes nonuniform, and a shadow is produced at the peripheral portion of a projection image. Hence, in order to adjust the brightness/darkness, cumbersome determination processes are required.

### BRIEF SUMMARY OF THE INVENTION

It is an object of the present invention to provide a projection video display apparatus and brightness adjustment method therefor capable of suppressing a shadow on a projection image, and accurately controlling brightness/darkness as required, even when a two-dimensional LED light source is used.

According to first aspect to the present invention, there is provided a projection video display apparatus comprising: a light source device which has two-dimensionally arrayed light-emitting elements; an optical space modulation element which receives light generated by the light source device, executes optical space modulation in accordance with a video signal, and outputs video light obtained by the optical space modulation; a projection device which projects the video light from the optical space modulation element to a screen via a projection optical lens; a light-emitting element driving device which ON/OFF-drives each of the light-emitting elements in the light source device; a designation device which designates a brightness level of the light source device; and an adjustment device which adjusts brightness of the light source device by controlling the ON/OFF driving operation of the light-emitting element driving device in accordance with the brightness level designated by the designation device, wherein the adjustment device compares the brightness level designated by the designation device with a current brightness level, controls the light-emitting element driving device to sequentially turn off the two-dimensionally arrayed light-emitting elements from outside to inside when the screen is designated to be darkened, and controls the light-emitting element driving device to sequentially turn on the two-dimensionally arrayed light-emitting elements from inside to outside when the screen is designated to be brightened.

According to second aspect to the present invention, there is provided a brightness adjustment method for a projection video display apparatus which modulates light generated by a light source which has two-dimensionally arrayed light-emitting elements by an optical space modulation element in accordance with a video signal, and projects video light obtained by the modulation onto a screen via a projection optical lens, comprising: designating a brightness level of the light source; and adjusting brightness of the light source by controlling the ON/OFF driving operation of the light-emitting element of the light source in accordance with the brightness level designated in the designating, wherein in the adjusting, the brightness level designated in the designating is compared with a current brightness level, the light-emitting element driving device is controlled to sequentially turn off the two-dimensionally arrayed light-emitting elements from outside to inside when the screen is designated to be darkened, and the light-emitting element driving device is controlled to sequentially turn on the two-dimensionally arrayed light-emitting elements from inside to outside when the screen is designated to be brightened.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an arrangement of a projection video display apparatus according to an embodiment of the present invention;

FIG. 2 is a flowchart showing a control procedure in an automatic brightness adjustment mode of the apparatus shown in FIG. 1;

FIG. 3 is a flowchart showing a control procedure in a manual brightness adjustment mode of the apparatus shown in FIG. 1;

FIGS. 4A and 4B are views showing examples of LED ON/OFF patterns in the manual brightness adjustment mode shown in FIG. 3;

FIG. 5 is a flowchart showing a control procedure in a color temperature adjustment mode of the apparatus shown in FIG. 1;

FIG. 6 is a view showing an example of a color temperature adjustment table used in the color temperature adjustment mode shown FIG. 5; and

FIG. 7 is a view showing examples of the LED ON/OFF patterns in the color temperature adjustment mode shown in FIG. 5.

### DETAILED DESCRIPTION OF THE INVENTION

An embodiment of the present invention will be described in detail below with reference to the accompanying drawing.

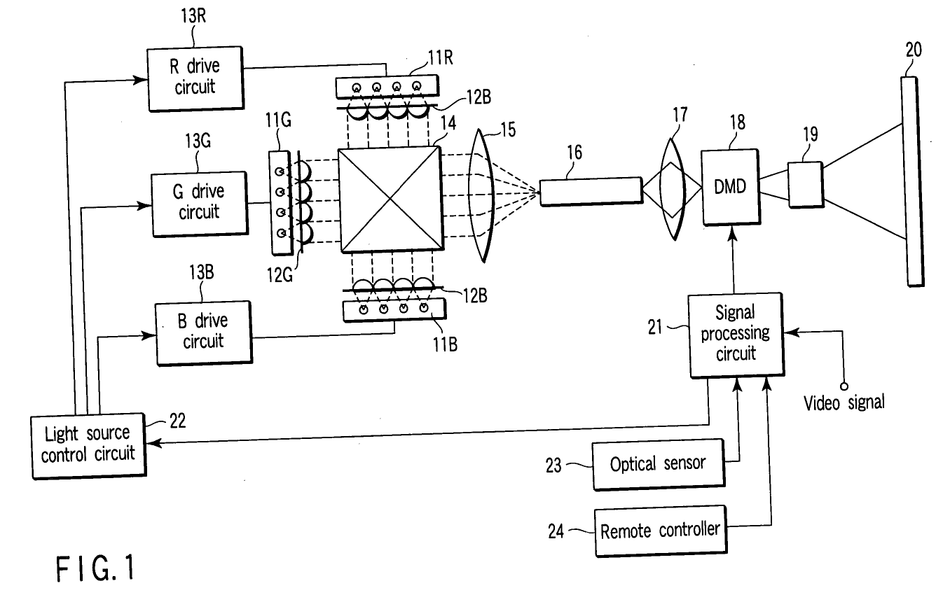

FIG. 1 shows an arrangement example of a projection video display apparatus according to the present invention. Reference numerals 11R, 11G, and 11B denote LED light sources each of which has a predetermined number of two-dimensionally arrayed LEDs. On the light-emitting surfaces of the LED light sources, color filters 12R, 12G, and 12B corresponding to R, G, and B are respectively mounted.

The LED light sources 11R, 11G, and 11B are connected to corresponding LED drive circuits 13R, 13G, and 13B, and sequentially emit light beams at predetermined time intervals in accordance with driving signals from the LED drive circuits 13R, 13G, and 13B, respectively. The LEDs included in each of the LED light sources 11R, 11G, and 11B are individually ON/OFF driven by the LED drive circuits 13R, 13G, and 13B.

The light beams emitted from the LED light sources 11R, 11G, and 11B enter the adjacent surfaces of a prism 14 via the respective color filters 12R, 12G, and 12B, and emerge outside from one irradiation surface. The light beams then enter a light tunnel 16 via an optical lens 15, and are uniformed. The light which has passed through the light tunnel 16 is applied to the video forming surface of a digital micromirror device (to be referred to as DMD hereinafter) 18 via an optical lens 17.

On the video forming surface of the DMD 18, many micromirrors are arrayed in a matrix. By controlling the tilt of each of the micromirrors, the light from the light source can be reflected and input to a projection lens system 19, or emerge outside in the direction away from the projection lens system 19. Therefore, when each of the many micromirrors arrayed in the matrix determines the reflection direction of the light in accordance with the video signal, the projection lens system 19 receives video light corresponding to the video signal. The video light from the projection lens system 19 is projected to a screen 20.

The video signals corresponding to R, G, and B are time-divisionally supplied from a signal processing circuit 21 to the DMD 18. The time-divisional process is controlled by a control circuit 22. The control circuit 22 controls the LED drive circuits 13R, 13G, and 13B so that the LED light sources 11R, 11G, and 11B corresponding to R, G, and B are time-divisionally turned on in synchronism with the time-divisional outputs of the video signals of R, G, and B from the signal processing circuit 21. Hence, the many micromirrors of the DMD 18 time-divisionally output the R, G, and B video light beams.

Upon reception of a command from the control circuit 22, the LED drive circuits 13R, 13G, and 13B execute LED ON/OFF control in accordance with the brightness, in addition to the time-divisional ON/OFF control of the LED light sources 11R, 11G, and 11B. In order to adjustment the brightness, an automatic adjustment mode for automatically adjusting the brightness in accordance with the detection result of an optical sensor 23 which detects the illuminance in an ambient environment, a manual adjustment mode for adjusting the brightness on the basis of a user's designation input operation using a remote controller 24 or the like, and a color temperature sync adjustment mode for controlling the brightness corresponding to each color in synchronism with color temperature adjustment are available.

In the above arrangement, the brightness adjustment of this invention will be described below.

The brightness of each of the LED light sources 11R, 11G, and 11B is determined in accordance with the number of ON LEDs. However, when the ON LEDs are decimated at random, a shadow is produced at the peripheral portion of the projection image, and the brightness becomes nonuniform on the entire screen. Hence, upon search for the positions of ON LEDs of the LED light source, it has been found that it is effective to sequentially turn off the two-dimensionally arrayed LEDs from outside to darken the screen, and to sequentially turn on the LEDs from inside to brighten the screen.

That is, the LEDs at the peripheral portion of the screen have low illumination efficiency, and the LEDs at the center of the screen have high illumination efficiency. Hence, the light quantity of the entire screen is quickly reduced when the LEDs at the center are turned off. To cope with this, the brightness can be relatively uniformly and gradually adjusted by sequentially turning off the LEDs from the peripheral portion (outside) as described above. Additionally, since the same brightness value can be obtained only by turning on a few LEDs, power consumption can be relatively saved.

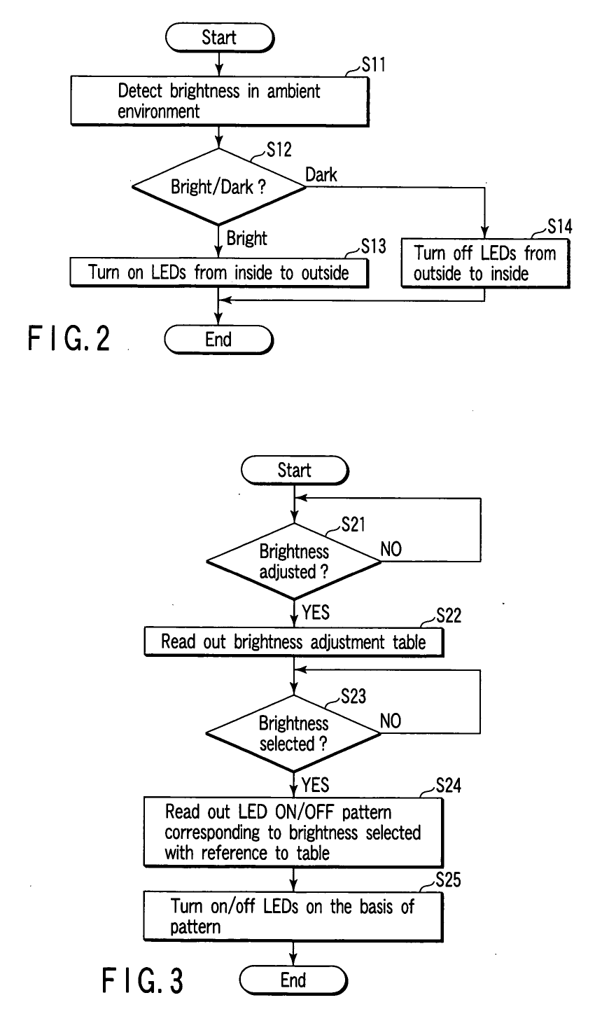

FIG. 2 is a flowchart showing the control procedure in the automatic brightness adjustment mode for automatically adjusting the brightness in accordance with the detection result of the optical sensor (e.g., an illuminometer) 23 which detects the illuminance in the ambient environment. First, the brightness in the ambient environment is periodically detected by the optical sensor 23 (step S11), and it is determined whether the screen is to be darkened in comparison with a predetermined threshold value (step S12). When the brightness in the ambient environment is higher than the threshold value, and the screen needs to be brightened, the LEDs of the light source are turned on from inside to outside (step S13). Alternatively, when the brightness in the ambient environment is lower than the threshold value, and the screen needs to be darkened, the LEDs of the light source are turned off from outside to inside (step S14). As described above, when the brightness/darkness on the screen is to be controlled in accordance with the brightness in the ambient environment, the LEDs are turned off from outside to inside, or turned on from inside to outside. As a result, the brightness on the screen can be relatively smoothly adjusted, and the shadow in the peripheral portion on the screen can be minimized.

When the brightness is further dynamically changed in accordance with a video level, a gray-level expression can be widened to obtain a high contrast. In this case, the peak value of the video signal is detected, and the detected peak value is set as “1”. The signal level is then divided by the peak value, and the obtained value is multiplied by the brightness value. As a result, the brightness can be adjusted in proportional to the peak value of the video signal.

Even when the brightness value of the screen is set within an optimal range, the user sometimes wants to darken the screen depending on video contents or for power saving. FIG. 3 is a flowchart showing the control procedure in the manual brightness adjustment mode for adjusting the brightness on the screen, i.e., the light source. Upon sensing the ON operation of a brightness adjustment button of the remote controller 24 (step S21), the projector apparatus is set in a brightness adjustment standby state. After that, a brightness adjustment table indicating relationships between the n-level (n is a natural number equal to or more than two) brightness prepared in an inner memory (not shown) in advance and the LED ON/OFF patterns is read out (step S22). Then, a user's brightness selection operation is determined (step S23), and the selected level of pattern is read out from the table information (step S24). In accordance with the readout pattern, the LEDs are controlled to be turned on/off via the LED drive circuits 13R, 13G, and 13B (step S25).

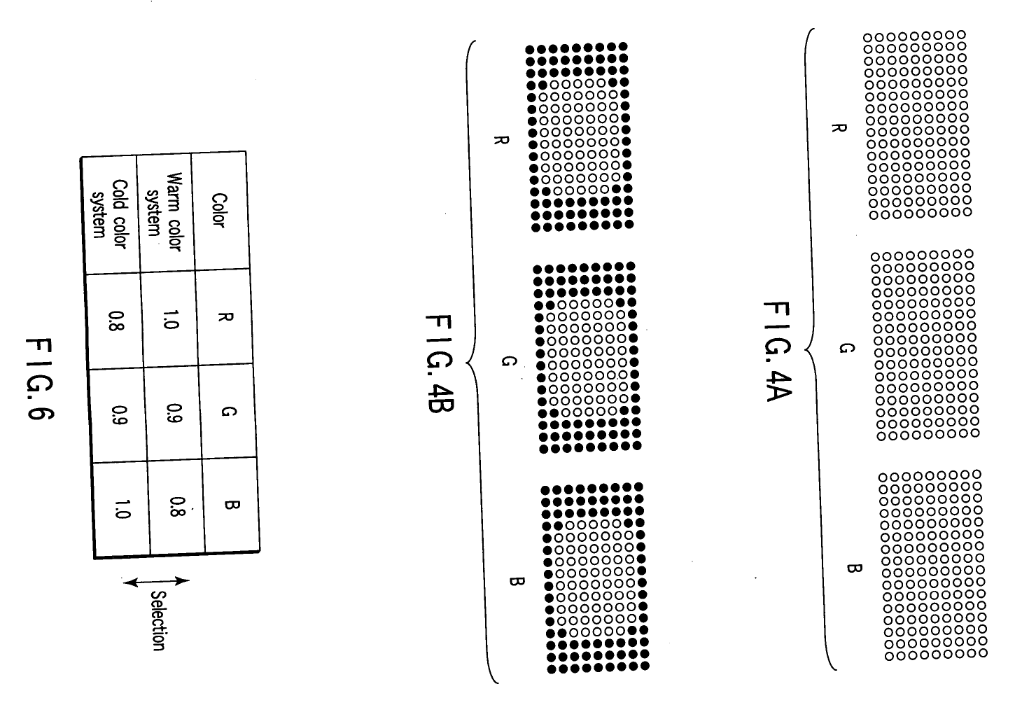

FIGS. 4A and 4B show examples of the LED ON/OFF patterns. In FIG. 4A, all the LEDs are on, and the screen is brightest. In FIG. 4B, only outer lines of the LEDs corresponding to R, G, and B are off, and the screen is darkened by one step. In order to darken the screen by one more step, the inner lines of LEDs next to the outer lines must be off.

In the above embodiment, the screen is darkened by one step by turning off the LEDs line by line from outside. However, the present invention is not limited to this. The number of ON/OFF LEDs may be increased or decreased every arbitrary number of lines, or every arbitrary number of LEDs in one line.

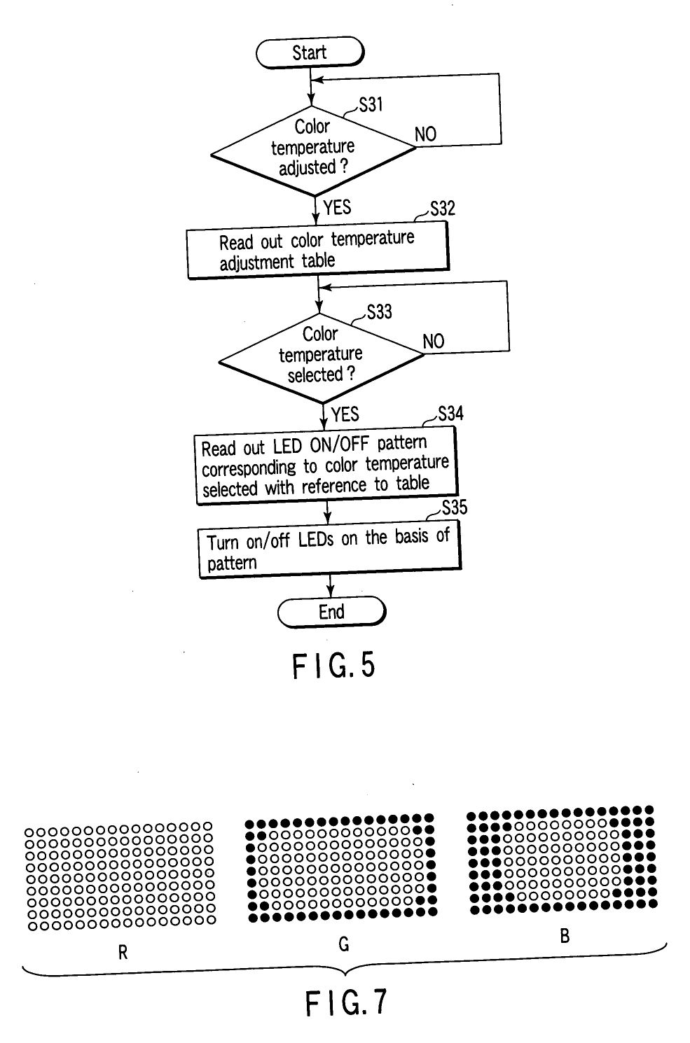

For color display, a color temperature adjustment mode is preferably prepared for vivid expression which is required in addition to natural color reproduction. FIG. 5 is a flowchart showing the control procedure in the color temperature adjustment mode. Upon sensing the ON operation of a color temperature adjustment button of the remote controller 24 (step S31), the mode is set in a color temperature adjustment standby state. After that, a color temperature adjustment table indicating relationships between the m-level (m is a natural number equal to or more than two) color temperatures prepared in an inner memory (not shown) in advance and the LED ON/OFF patterns of R, G, and B is read out (step S32). Then, a user's color temperature selection operation is determined (step S33), and the selected level pattern is read out from the table information (step S24). In accordance with the readout pattern, the LEDs are controlled to be turned on/off via the LED drive circuits 13R, 13G, and 13B (step S35).

FIG. 6 shows an example of the color temperature adjustment table. In this example, only one color temperature pattern of a warm color system and only one color temperature pattern of a cold color system are prepared for RGB in the table. While the ratio of brightness of the warm color system is increased in the order of B, G, and R, the ratio of brightness of the cold color system is increased in the order of R, G, and B. Of course, the color temperature can be finely adjusted when increasing the number of steps for the warm and cold color systems.

Note that, as described above, the LEDs of R, G, and B are turned on from inside to outside, and turned off from outside to inside. FIG. 7 shows an example of the LED ON/OFF pattern for color temperature adjustment. In this example, when the color temperature is set low, the LEDs arranged at the peripheral portions of G and B are off, in consideration of the balance.

As described above, even when the two-dimensional LED light source is used, the apparatus of the present invention can suppress the shadow on the projection image, and accurately control the brightness/darkness as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A projection video display apparatus comprising:
a light source device which has two-dimensionally arrayed light-emitting elements;
an optical space modulation element which receives light generated by the light source device, executes optical space modulation in accordance with a video signal, and outputs video light obtained by the optical space modulation;
a projection device which projects the video light from the optical space modulation element to a screen via a projection optical lens;
a light-emitting element driving device which ON/OFF-drives each of the light-emitting elements in the light source device;
a designation device which designates a brightness level of the light source device; and
an adjustment device which adjusts brightness of the light source device by controlling the ON/OFF driving operation of the light-emitting element driving device in accordance with the brightness level designated by the designation device,
wherein the adjustment device compares the brightness level designated by the designation device with a current brightness level, controls the light-emitting element driving device to sequentially turn off the two-dimensionally arrayed light-emitting elements from outside to inside when the screen is designated to be darkened, and controls the light-emitting element driving device to sequentially turn on the two-dimensionally arrayed light-emitting elements from inside to outside when the screen is designated to be brightened.

2. An apparatus according to claim 1, wherein the designation device designates the brightness level in accordance with a user's operation input.

3. An apparatus according to claim 1, wherein the designation device includes an optical sensor which measures a peripheral illuminance on the screen, and designates the brightness level on the basis of a peripheral temperature obtained by the optical sensor.

4. A projection video display apparatus comprising:
a plurality of light source devices each of which has two-dimensionally arrayed light-emitting elements, and emits one of three primary colors of R, G, and B;
an optical space modulation element which sequentially receives light beams time-divisionally generated by said plurality of light source devices, executes optical space modulation in accordance with a video signal, and outputs video light obtained by the optical space modulation;
a projection device which projects the video light from the optical space modulation element to a screen via a projection optical lens;
a light-emitting element driving device which ON/OFF-drives the light-emitting elements in said plurality of light source devices;
a designation device which designates a brightness level of the light source device; and
an adjustment device which adjusts brightness of the light source device by controlling the ON/OFF driving operation of the light-emitting element driving device in accordance with the brightness level designated by the designation device,
wherein the adjustment device compares the brightness level designated by the designation device with a current brightness level, controls the light-emitting element driving device to sequentially turn off the two-dimensionally arrayed light-emitting elements from outside to inside when the screen is designated to be darkened, and controls the light-emitting element driving device to sequentially turn on the two-dimensionally arrayed light-emitting elements from inside to outside when the screen is designated to be brightened.

5. An apparatus according to claim 4, wherein the adjustment device synchronously adjusts the brightness levels of the light sources of R, G, and B on the basis of the designated color temperature.

6. A brightness adjustment method applied to a projection video display apparatus which modulates light generated by a light source which has two-dimensionally arrayed light-emitting elements by an optical space modulation element in accordance with a video signal, and projects video light obtained by the modulation onto a screen via a projection optical lens, comprising:
designating a brightness level of the light source; and
adjusting brightness of the light source by controlling the ON/OFF driving operation of the light-emitting element of the light source in accordance with the brightness level designated in the designating,
wherein in the adjusting, the brightness level designated in the designating is compared with a current brightness level, the light-emitting element driving device is controlled to sequentially turn off the two-dimensionally arrayed light-emitting elements from outside to inside when the screen is designated to be darkened, and the light-emitting element driving device is controlled to sequentially turn on the two-dimensionally arrayed light-emitting elements from inside to outside when the screen is designated to be brightened.

7. A method according to claim 6, wherein in the designating, the brightness level is designated in accordance with a user's operation input.

8. A method according to claim 6, wherein in the designating, the brightness level is designated on the basis of a peripheral illuminance measurement result on the screen.

9. A brightness adjustment method applied to a projection video display apparatus which has two-dimensionally arrayed light-emitting elements, and modulates light beams time-divisionally generated by said plurality of light source devices emitting three primary colors of R, G, and B, and projects the video light to a screen via a projection optical lens, comprising:
designating a brightness level of the light source device; and
adjusting brightness of the light source device by controlling the ON/OFF driving operation of the light-emitting elements of said plurality of the light source devices in accordance with the brightness level designated in the designating,
wherein in the adjusting, the brightness level designated in the designating is compared with a current brightness level, the light-emitting element driving device is controlled to sequentially turn off the two-dimensionally arrayed light-emitting elements from outside to inside when the screen is designated to be darkened, and the light-emitting element driving device is controlled to sequentially turn on the two-dimensionally arrayed light-emitting elements from inside to outside when the screen is designated to be brightened.

10. A method according to claim 9, wherein in the adjusting, the brightness levels of the light sources of R, G, and B are synchronously adjusted on the basis of the designated color temperature.
